(19) United States
(12) Patent Application Publication
(10) Pub. No.: US 2004/0060441 A1
(43) Pub. Date: Apr. 1, 2004

(54) Gaseous diffusion enrichment modular unit

(76) Inventor: Luis Eduardo Juanico, Buenos Aires (AR)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 10/447,555

(22) Filed: May 29, 2003

(30) Foreign Application Priority Data
Nov. 16, 2001 (WO) PCT/BR01/00131

(51) Int. Cl. B01D 53/22

(52) U.S. Cl. 96/4

(57) ABSTRACT

A gaseous diffusion enrichment modular unit and gaseous diffusion enrichment plant, comprehending a gaseous diffusion enrichment unit of the enrichment cascade type, being an integrated module containing all the elements of the unit, with several flows of circulation with different enrichment degrees, comprehending an axial compressor in simultaneous work of compression of said flows, a diffuser with membranes. The diffused (enriched) fluid passes through to the compressor in another section to accomplish the following enrichment phase and the non-diffused flow outlet is connected to an injector to even the pressures and to recycle the depleted material. Said modular unit of isotopic enrichment integrates multiple enrichment phases to achieve a high separative efficiency by means of the internal recirculation of a fraction of the diffused fluid in each phase. The multiflow axial compressor is driven by a gas turbine and the outgoing gases of the turbine and the heat generated in the process are injected in a thermal cycle. In the center of the unit is a probe to perform non-destructive analysis. The gaseous diffusion enrichment plant comprehends said enrichment modular units connected in series and the numbers of the phases of one or more said units are different. An application of the present invention is its use for the isotopic separation of uranium hexafluoride in gaseous phase.

### FIELD OF THE INVENTION

This invention refers to a gaseous diffusion isotopic enrichment modular unit with a high degree of integration of enrichment phases that enables better separative efficiency and cascade drawing flexibility, and to a gaseous diffusion enrichment plant composed of said modules. One application of this invention is the use of said integrated modules, arranged either in series or cascade, in order to set up a gaseous diffusion enrichment plant for isotopic separation of uranium hexafluoride in gaseous form. Another application is the separation of the several chemical compounds that, similar to isotopes of a single element, have different molecular weights.

Said isotopic enrichment modular unit integrates multiple enrichment phases so as to achieve high separative efficiency by means of internal recirculation of a fraction of diffused fluid of some or all phases without increasing the number of connections. This unit enables better economic performance of low-scale production plants and energy savings per unit of production through physical integration of different-phase components into a single ring-shaped container and the use of a high-efficiency compressor. Its design is characterized by an innovative transparent protection system.

Its energetic efficiency can further be improved by using the turbine outlet gases that provide the module with mechanical work and/or heat generated during the process, in a thermal cycle, or to preheat the module during the startup process or to keep it at a constant temperature while not operating.

### BACKGROUND OF THE INVENTION

From the beginning, gaseous diffusion plants have been built on separating or separative unit bases connected in series in a given cascade schema so as to characterize what is better known as a gaseous diffusion plant.

Gaseous diffusion plants are composed of a large number of identical phases connected in series until a given enrichment is obtained. In theory, each of these separating units should be of a different size, in order to achieve the ideal cascade schema performance of the plant (with a flow mixture of ever-identical enrichment). Phases are basically distinguished by each one's work flow. However, sizes of separating units are currently restricted to three each one's work flow. However, sizes of separating units are currently restricted to three (typically), thereby facilitating construction and assembly tasks as well as the level of their standardization.

The objective of these plants is to perform isotopic separation of a given material based on the difference of mass between the isotopes that integrate it. Typically, commercial plants for uranium enrichment are designed to reach a 5% enrichment of U²³⁵ (uranium 235), starting from natural uranium at 0.71% of U²³⁵. Gaseous diffusion technology is currently characterized by a considerable production capacity in function of the existing large-sized commercial plants.

Among the enrichment technologies developed so far, gaseous diffusion is the least proliferating one due to its operation profile (slow transients, high level of uranium accumulation in the cascade during operation and low capacity to pass on to proliferating configurations).

Each separative unit boasts individual components connected by pipelines, namely a compressor and its corresponding engine to impel the process fluid, a heat exchanger to maintain the process at a constant given temperature, diffusers for isotopic separation, a compressor for recycling, pipelines and process-associated valves and ancillary systems that ensure normal operation.

In a symmetrical countercurrent configuration of an enrichment cascade during gaseous diffusion phases (composed by porous barriers), three connections to external flows are identified: the inlet or supply of fluid to be separated and two salients: the fraction diffused through the porous barrier (enriched) and the remaining fraction (depleted), all characterized by the cut-off rate (diffused outflow by total flow). The diffused flow goes into the inlet of the backward phase, while the depleted fraction goes into the inlet of the forward phase. Each separation and enrichment phase is known as base cell.

Depending on the size of the plant (production capacity) and according to the outflows involved, positive, centrifugal or axial displacement compressors are used, with respective efficiency of 65%, 75% and 85%, typically.

These diffusion plants require energy to perform the mechanical work of compression, for which they use electric engines supplied by transformation of a primary source of energy with the corresponding efficiency loss.

With current technology of gaseous diffusion plants, only in plants with a production capacity in excess of 3 million S.W.U. would all compressors be within the optimal axial band (greater efficiency).

The separative work unit (S.W.U.) is the difference of free energies from one enrichment state to another of a compound of two isotopic varieties for one kilogram of mass.

Diffusion plants need to operate at a constant process temperature higher than ambient temperature. For that, all process components are thermally insulated by an external closure in order to acclimatize the surrounding air.

The use of uranium hexafluoride as a process gas implies the need for an excellent insulation of the exterior. This is based on the operators' safety due to the fact that the material is a chemically toxic reagent with water, and is a reason why the gas should not leave the process circuit; and for operational reasons, the air with ambient humidity should not enter the circuit. This calls for special maintenance procedures' especially on the sealing of compressors' rotating axes.

### SUMMARY OF THE INVENTION

For the purpose of solving the inconveniences mentioned, the novelty of the invention consists in modular enrichment units, so that each modular unit of the invention replaces a variable number of enrichment units used in present-day plants, with the result that an integral and functional plant of advantageous features is obtained.

The invention allows high separative efficiency levels in this type of low-scale production plants through the integration of a variable number of phases per module in order to fix the total flow that must impel the compressor in simultaneous work at levels that allow the use of high-efficiency turbocompressors (axial) in the entire enrichment cascade, and through the internal recirculation of a fraction of the fluid in some or all phases that compose it.

The invention allows high availability levels of a commercial plant due to the reduction and/or elimination of sealings on rotating axes, which reduces the number of operation detentions.

The invention also allows high energetic efficiency levels by using a gas turbine as a compressor impeller, directly changing a primary source of energy into mechanical work. The demand for primary energy as per product unit may be reduced by the use of turbine combustion gases and the thermal energy of the process in a regenerative thermal cycle.

In addition, the invention allows construction of large-scale plants consisting of several small-scale plants operating independently, thereby significantly improving its efficiency in partial load regimens, e.g. plants ranging from 250000 to 500000 S.W.U.

The efficient use of the axial compressor can be achieved by allowing several parallel currents of different concentrations or enrichments to go through, making it possible to apply them on small-sized gaseous diffusion plants and to reduce the number of plant compressors as well as to simplify operation and maintenance.

No modifications are introduced in the operation of the compressor, i.e. it operates the way it was designed to, the only difference being that the flow separation must be performed both on the inlet and on the outlet, using for such purpose their flow predirecting devices, outlining them appropriately.

This type of compressor operation has already been successfully tested, demonstrating that when it comes to compressors having flows of a chemically identical gas with several isotopic concentrations injected into them, the same takes on itself to compress it successfully, at minimal mixture levels of different currents.

The enrichment unit of the invention uses the described axial compressors, which will be called multiflows, to evenly distribute along its circumference the currents of different concentrations that go into it; together with the powerful multilayered membranes at an outflow separating cut-off rate between 0.4 and 0.6, preferably equal to 0.5 and at a work pressure of 0.1 to 2 atmospheres. The way to minimize the compressor mixture among neighboring currents of different-concentration flows is to unfold them into two or more compressor supply and outlet currents.

In the present invention, by enrichment unit or module one understands the set comprised of the compressor and its respective engine, the set of separating elements or membranes, the diffuser (with its internals, i.e. flow separators, flow directing devices, component supports), the external pipelines and valves, the recirculators and related protection system.

The diffusion phases are comprised of two consecutive sections of porous tubes through which the fluid circulates while partially diffusing to the external space. The sections are connected to each other by means of a plenum that allows differentiating the number of tubes in each section so as to fix the fraction of diffused fluid in each of these sections freely. The non-diffused outlet flow (depleted) supplies the previous phase, while the enriched outlet supplies the following enrichment phase, having previously passed through the thermal exchanger and the compressor.

Each of these modules is an elementary constituent of an enrichment plant and with its connection in series it ends up configuring an enrichment plant.

Each of these modules can manipulate several different enrichment currents (according to the place they occupy in the enrichment cascade), which ranges from one (operating as an enrichment unit in present-day plants) to several ones.

The modularity concept used in the invention consists of integrating the several components constituting the separating unit for the purpose of reducing interconnections among units, simplifying both the connection between them and the servicing they demand from the ring-shaped location of the separative phases surrounding the ordinary compressor.

The main objective of the enrichment modular unit of the invention is to improve separative and energetic efficiency and to simplify construction and assembly, operation and maintenance of gaseous diffusion enrichment plants by creating a new cascade concept that integrates an arbitrary number of separating phases into a single ring-shaped container that includes porous membranes or diffusers where separation takes place, a single axial compressor operating simultaneously on the compression of several currents of different concentrations in parallel, heat exchangers to maintain the process at a constant given temperature, recirculators of the gas that did not diffuse through the membranes, pipelines and valves related to the process, and that uses a separating cascade symmetrical countercurrent schema that can include internal recirculation of a fraction of the diffused fluid at each phase without increasing the complexity of connections.

The enrichment modular unit of this invention integrates multiple enrichment phases in order to reach a high level of separative efficiency by internal recirculation of a fraction of the diffused fluid of each phase in the separating base cell. This improves the efficiency of the base cell, where separation and enrichment take place, using internal recirculation on an arbitrary fraction of the total outflow diffused, in such way as to integrate two phases in the conformation of the base cell, reducing the number of connections to a minimum.

In addition, the integration of phases into one module enables great flexibility in the number of enrichments present in each module (or what is equivalent, the size of each enrichment phase), without increasing a diversity of components. Thus, it is possible to increase efficiency of the cascade schema by performing it approximate to the ideal cascade (maximum efficiency). The second objective of the invention is to improve the energy efficiency of the module by using the outlet gases of the gas turbine that provides the module with mechanical work and the heat generated during the process, in thermal cycle. One possibility is to use these gases to evaporate water that will generate work through expansion in a steam turbine coupled to the gas turbine, with a view to reducing fuel consumption.

Using the enrichment unit of the invention with gas turbines instead of electric engines as a way to generate mechanical energy radically changes the economic size of a gaseous diffusion plant, and the plant can be located at a place where a large reserve of gas is at hand.

A further objective of the invention is to improve the maintenance of the gaseous diffusion plant formed by these modules, reducing the number of sealings in total rotating axes for a given number of phases. The concept of physical integration of several phases with a single compressor not only meets this purpose but can also mechanically turn off the axis of the compressor and its engine, thus eliminating sealing in this case.

For the purpose of simplifying plant construction and assembly, a modular drawing is used which is based on a ring-shaped container that integrates several phases and eliminates most connections among them, where diffusers and central area are located, and the multiflow axial compressor.

A further objective of the invention is to reduce the risk of proliferation by means of an inherent non-intrusive system coupled among several process units in order to calculate the accumulation level of uranium in each module of the cascade during operation. For such purpose, the unit of this invention incorporates interior devices that enable application of a simple and non-intrusive high-precision protection system which ensures non-proliferation.

One application of this invention is the use of several of these units coupled in series to form a uranium enrichment commercial plant with a high level of separative and energy efficiency through gaseous diffusion technology.

A further application of this invention is in the separation of gaseous hydrocarbons, as natural gases.

### BRIEF DESCRIPTION OF THE DRAWINGS

In order to better understand this invention and the advantages mentioned, a detailed description of an example of preferential accomplishment of the enrichment modular unit of this invention based on the enclosed drawings is as follows, in which:

FIG. 1 shows an embodiment of the invention having a connection schema of an enrichment modular cascade with internal recirculation, as shown in FIG. 3b.

FIG. 2 shows the cross section of a multiflow axial compressor, with several flow circulation sections.

FIG. 3a shows two diffusers connected in series, which defines a new base cell, within which the internal recirculation is produced, according to the previous art in enrichment. This connection schema is known in the literature as “double diffuser.”

FIG. 3b shows an exchange base cell schema of the invention unit, including the internal recirculation of a fraction of the diffused fluid, during which both phases are integrated and thus it is possible to fix the fraction of the recirculated diffused fluid by means of the internal dividing partition position.

FIGS. 4a and 4b show the schemas in cross and longitudinal sections, respectively, of a configuration of the ring-shaped container that does not use the internal recirculation in any of the phases and that shows the consecutive location of the phase diffusers.

FIG. 5 shows the configuration in cross section, of another configuration of the ring-shaped container, the location of the phase diffusers, the injectors, the recyclings between base cell fractions and the probe, according to an embodiment of the invention, which includes the internal recirculation in all phases composing the module (using the dividing partitions marked in the figure with full lines) or without recirculation as in the previous figure (dotted lines).

FIG. 6 shows another embodiment of the invention in a cascade schema with physical integration of the phase diffusers, using the dividing partition arrangement for internal recirculation in all phases.

FIG. 7 shows an embodiment of the invention in an enrichment modular cascade connection schema with internal recirculation, integrated phases, and the incorporation of an evaporator and a steam turbine between the gas turbine and the enrichment module. The evaporator takes advantage of the residual heat of the combustion gases in the turbine and the process heat extracted from the heat exchangers to generate steam to perform mechanical work in the steam turbine mounted on the same axis of the gas turbine.

FIG. 8 shows the vertical longitudinal sectional diagram of the unit depicted in FIG. 9.

FIG. 9 shows a partial cutaway view of an embodiment of the invention.

In all figures the same reference numbers correspond to the same or equivalent constituent elements of the enrichment modular unit of the invention.

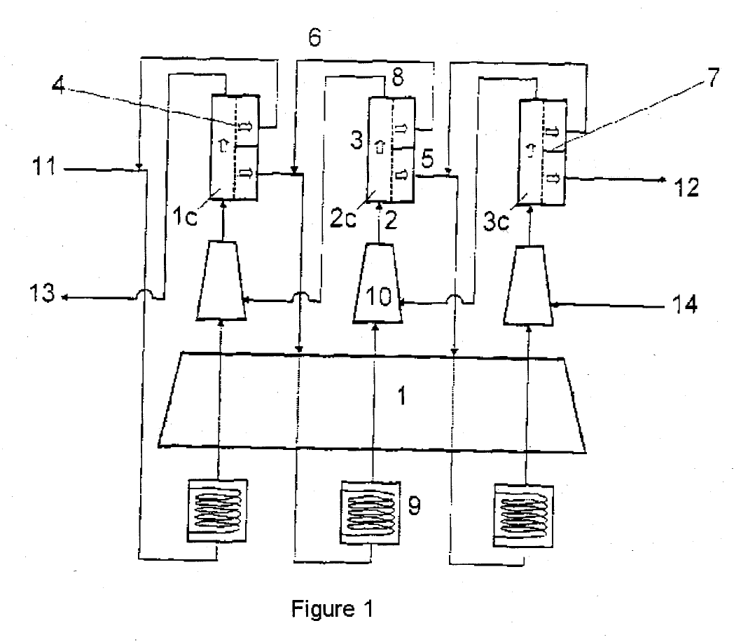

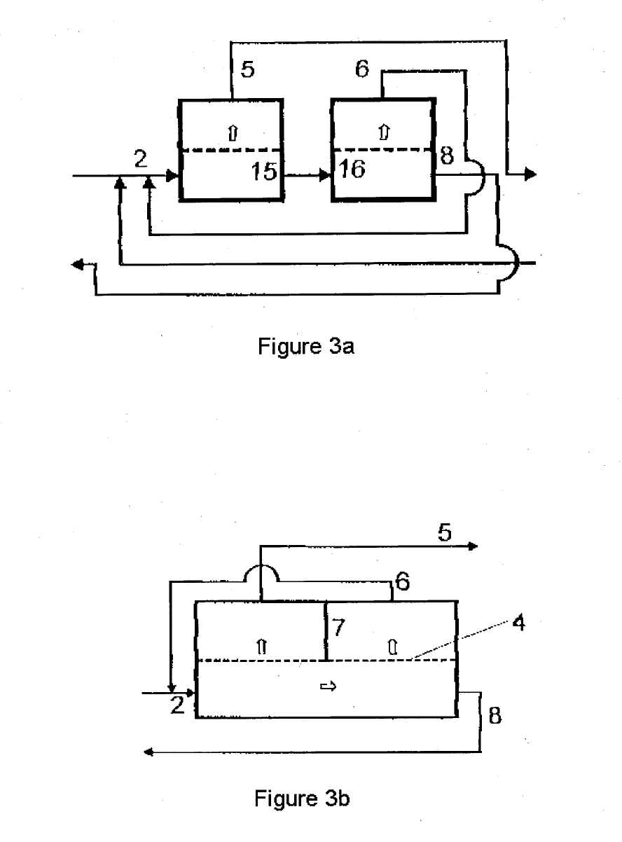

FIG. 1 shows in simplified form a process diagram of an embodiment of the enrichment unit of the invention with internal recirculation as shown in FIG. 3b, in the which the diffusers of separative phases are not physically integrated. FIG. 1 represents the case of a multiflow axial compressor 1, with three currents having different concentrations 1c, 2c and 3c. Upon leaving the compressor, each current is physically separated from the others. Each flow 2 goes to a diffuser 3 and the flows that diffuse through the porous membrane 4 come out from it, in the first section of the diffuser 5 and in the second part of the diffuser 6, which are separated by a dividing partition 7, as well as the remaining or recycled flow 8 that was not diffused. The diffused flow goes to a heat exchanger 9 to its posterior reentrance in the compressor in a displaced position (following phase of the enrichment) in relation to the previous phase. The flow that had not been diffused 8 will be recycled, being mixed in the recirculator or in the injector 10.

The unit of the FIG. 1 is configured by diffusers 3, arranged in series, connected to a compressor 1, with parallel flows. The diffusion cascade is formed by units, as described, arranged in series. In the process line four external connections are pointed out, two unit inlet connections and two outlet connections. In the progression or enrichment line the flow enters the first phase of the unit through the position 11, while the position 12 corresponds the outlet of the last phase containing the maximum enrichment, which is connected to the inlet 11 of the following unit. In the retrogression or recycling line the flow leaves the unit through position 13 corresponding to the recycling of the first phase, while the position 14 corresponds to the inlet of the recycled component in the last phase coming from the following unit.

As the non-diffused flow should be recirculated to the inlet of the of previous diffusion phase, an injector 10 should be used in a recirculator for each different concentration current, with the purpose of making the recycling flow and the flow originating from the compressor go together into the diffuser, without loss due to the mixture with other currents, and with high efficiency. This injector has characteristics of a venturi, without mobile parts, and it simplifies or eliminates the drawing and maintenance of the classic axial compressors for recycling located to the rear of the diffuser in current plants. This point differs from the classic drawing, where the recycled component is injected in the last phase of the axial compressor or in other return compressor for drawings with centrifugal compressors or of positive displacement.

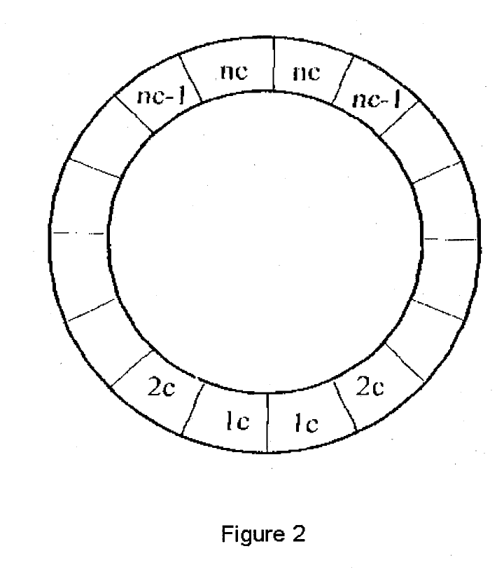

Given that the idea proposed uses a compressor to compress flows with several enrichments (in other words, a gas chemically identical in all cases, except that its isotopic compounds are different), an inlet and an outlet of the compressor should be performed so as to reduce its mixtures. This is obtained with the distribution used, according to FIG. 2, to inject the gas to be enriched within the compressor, in which it is possible to see that the inlet flows were divided in two, with the purpose of minimizing in the inlet, the gradient among several neighboring isotopic concentrations so as to reduce the losses due to the mixture within the compressor.

For that reason, the distribution of flows to the inlet of the compressor shown in FIG. 2 is accomplished, in the which the multiflow axial compressor section is observed with the distributions of “nc” currents with growing concentrations (1c, 2c, . . . , nc-1, nc). Particles go through the compressor describing a helical trajectory (helical band) with an angular dispersion, to enter the diffusion phase. If there is no angular dispersion in the compression process, the concentration in the outlet of each circular section would be same as the concentration in the inlet, rotated from a certain angle. Due to the turbulent diffusion (radial, axial and tangential), and the existence of secondary flows, each flow is mixed to a certain degree with its neighbors, with little significance. To minimize the mixing activity in the compressor, the flows are divided in two or more currents, as previously mentioned.

The separative capacity of a phase can be characterized by its separation factor defined as the quotient between the relative abundances of the isotope or chemical compound of interest and the enriched or depleted outlets.

One way of increasing this factor consists of connecting two diffusers in series (this configuration also being known as a double diffuser) defining a new base cell, as shown in FIG. 3a. The depleted outlet of the first diffuser 15 is connected to the inlet 16 of the second diffuser, and the outlet of the enriched component of the second diffuser 6 is connected to the supply of the first diffuser 2 to constitute an internal recirculation of flow within the cell. The depleted outlet of the second diffuser 8 and the enriched outlet of the first one 5 constitute the depleted and enriched cell outlets, respectively. In this defined cell, an enrichment cascade can be constituted from a symmetrical schema of countercurrent connection.

The increase of the separation factor in the configuration described in relation to the classic cascade schema (without internal recirculation), is obtained by means of the effective supply concentration increase of the cell due to the internal recirculation, resulting in a higher enrichment of the outlet 5 of the cell.

The flow ratio of the defined cell between the enrichment in the second diffuser 6 and the total diffused is called the internal recirculation fraction.

This possibility of recirculating the diffused fluid to improve the efficiency of the 10 enrichment cascade base cell is widely known in the literature of gaseous diffusion. In this case, the use of an internal recirculation fraction significantly different from approximately 0.5 would imply the consideration of two sizes of different phases and a larger number of interconnection pipelines which could impair the degree of enrichment cascade standardization. It may be noted that higher recirculation fractions of increase the separative efficiency of the cell. The recirculation fraction can be optimized considering a commitment between the separative capacity and the energy consumption, generally settling down values above to 0.5 that could vary according different phases within the cascade schema. In illustration 3b, a way of improving the separative efficiency is observed whereby integrating the two phases connected in series to configure the base cell into a single phase will cause the dividing partition position 7 to divide the diffused fluid area with the objective of fixing the internal recirculation fraction. As the flow goes through the cell, the overpressure is gradually depleted as part of it is diffused through the porous membrane 4 to the enrichment area (the lowest pressure). For this reason, the separative efficiency of the phase is at a maximum in the first cell supply differential element, and at a minimum in the last one (outgoing). By dividing the area of the diffused flow according to this criterion, the first of them will have a higher enrichment in relation to the latter one. If these areas are kept separated, and if the one with lower enrichment is used to increase the enrichment of the cell supply, the separative efficiency of the latter is increased. This is used as a phase drawing recognized as previous art, formed by two membranes or sets of equal porous tubes 4 connected by a plenum within which the fluid to be enriched circulates. An external container confines the diffused fluid through them (enriched). By fixing the ratio of the number of separation tubes between both sets separated in this invention by a dividing partition 7 and/or fixing the dividing partition position, the ratio among the diffusion areas is fixed and, therefore, the recirculation fraction. This fraction of the diffused flow is achieved by recirculating without adding connections and using the physical integration of the phases.

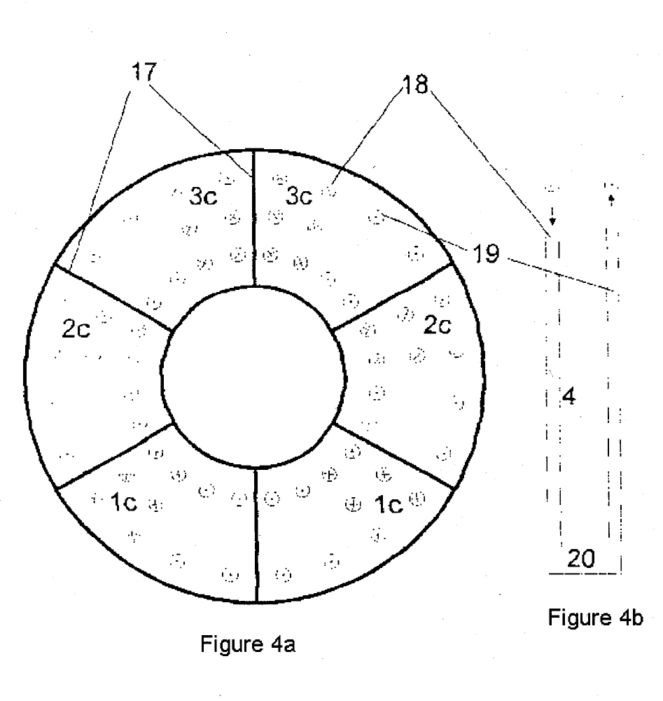

In FIGS. 4a and 4b, schemas of cross and longitudinal sections are observed, respectively, from an embodiment of the ring-shaped container and the location of the diffusers of the phases corresponding to a configuration of the module that does not use the internal recirculation in any of the phases composing it. By means of the use of vertical dividing partitions six angular sections are determined, where diffusers are located. This modular unit has two parallel process lines, each one having three consecutive phases of cascade, with isotopic concentrations of growing supply 1c, 2c and 3c defined by the dividing partitions 17. Within each angular section two areas are recognized, each one representing a group of porous tubes 4 with different circulation orientation of the fluid to be diffused. The direction of the fluid circulation within the tubes is normal to the section plan in FIG. 4a; the incoming direction is represented by a cross 18 and the outcoming by a point 19. The fluid supplied to each section goes through the interior of the tubes, firstly in the incoming orientation segment, the plenum 20 and finally the in the outgoing orientation segment. The fluid diffused through the tubes (enriched) of each stage re-enters the following stage by means of the impel of only one compressor. On the other hand, in the depicted embodiment, the depleted fluid that leaves the end extremity of the tubes is recirculated to the previous phase supply by means of injectors.

In addition, this invention presents other possible configurations from the quality of space integration of multiple phases located at a circular crown as described, together with the original use of diffusers comprised of two sets of different numbers of tubes and a dividing partition between them. This configuration does not add any complexity to the drawing without internal recirculation described above, and allows one to fix the fraction of the flow to be internally recirculated, avoiding the incorporation of connection lines, as those shown in FIGS. 3a and 3b.

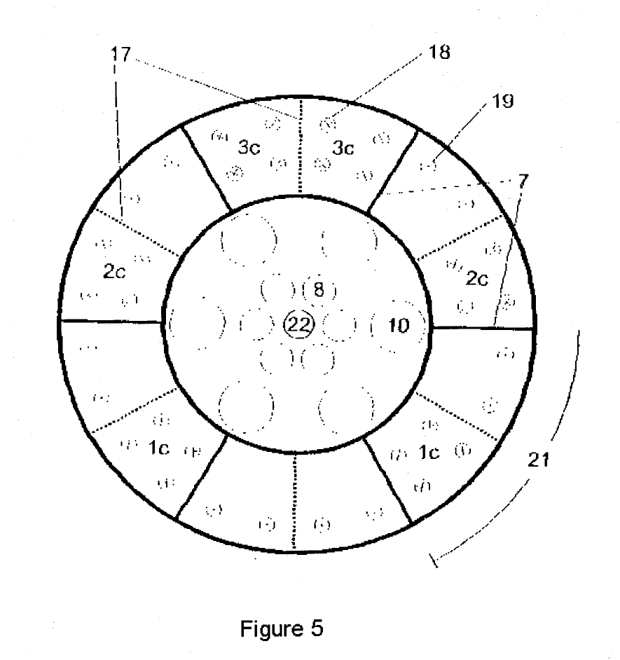

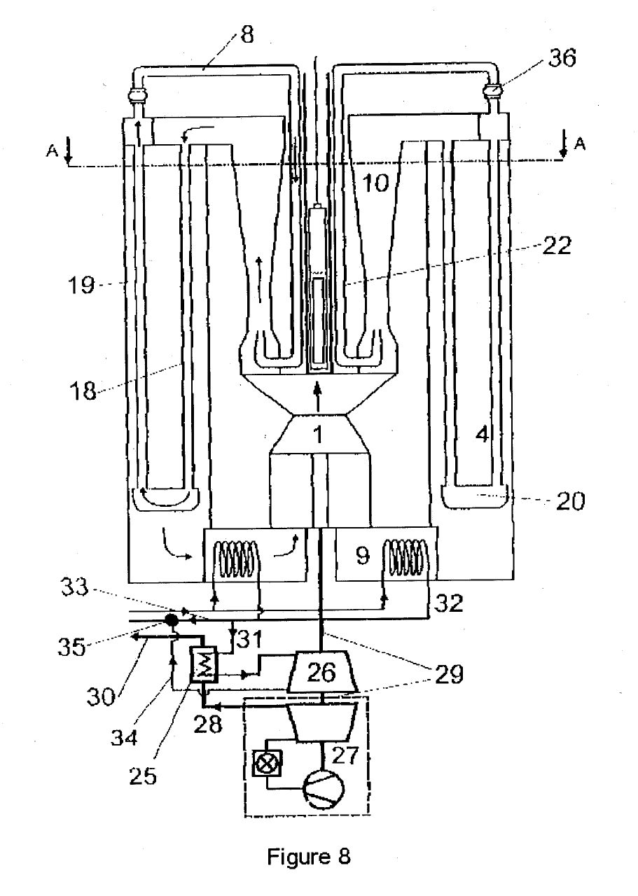

Another embodiment of the invention uses the internal recirculation in the phases composing it, shown in FIG. 5, being that the same is a cross section A-A of the embodiment detailed in FIG. 8. This simply modifies the previous position of the vertical dividing partitions 17 in FIG. 4 through the new position 7, with the objective of separating the areas corresponding to the incoming and outcoming flows of the same angular sector (according to the configuration in FIG. 3b). This way, it is possible to integrate a new angular sector 21, two different enriched outlets, one corresponding to the set of tubes of the outcoming flow 19 of a phase with that of the set of tubes of the incoming flow of the previous phase 18, to achieve the internal recirculation of this last flow in the supply phase. Notice that in FIG. 5, the dividing partitions 17, that change their position to the 7 o'clock position, are those marked in dotted lines. In the central part of the ring-shaped container, the injectors 10, the recycling pipelines 8 and a stock control probe 22 are located.

The highest separative efficiency with the internal recirculation of the fluid and its fraction is obtained without the need to add interconnection pipelines and diffuser units of different size. The recirculation degree can be chosen freely, without any additional cost, by means of the location of a dividing partition 7 that divides the area of fluid diffused and/or through the variability of the area of diffusion of the membranes 4. Those porous membranes, or sets of porous tubes, that constitute the separative element, are configured by a great number of parallel tubes of small diameter, formed by an ascent segment and a descent segment, connected by a plenum.

The number of tubes of each segment (or the ratio between them) may be varied to fix the fraction of the diffused flow that internally recirculates in the phase.

As is observed in FIG. 5 and in the sectional view of FIG. 8, the center of the enrichment unit of the invention is free from all bodies except in the position of the compressor. This is to incorporate the center probes 22 of Non-Destructive Analysis (N.D.A) with spectrometry techniques y, y_{——}total, neutronic and active measurements (techniques developed with exploration geology and mining purposes). This configuration allows the taking of measurements in situ of unit protections. The system to be measured presents rotational symmetry around the detector and a solid angle for a measurement approximating a value of 4π. The great proximity between the source and the detector decreases notably the relative effect of the neighboring units.

If the module is vertically located, the generated anisotropy is eliminated by the y-and-neutron interaction with the soil and if the enrichment units are placed with such a separation that reduces the couplings among the neighboring phases in the measurements of protections, a system drawing of protections can thus be achieved with very little uncertainty.

This wide incorporation of the protections in the drawing presents great differences in relation to the classic drawing, where placing the detectors outside the diffuser unit introduces additional uncertainties that are added to interferences due to soil (in the case of the horizontal units) and neighboring units, once the distances among them are not fixed, and considering the couplings in measurements through neutronic and y techniques.

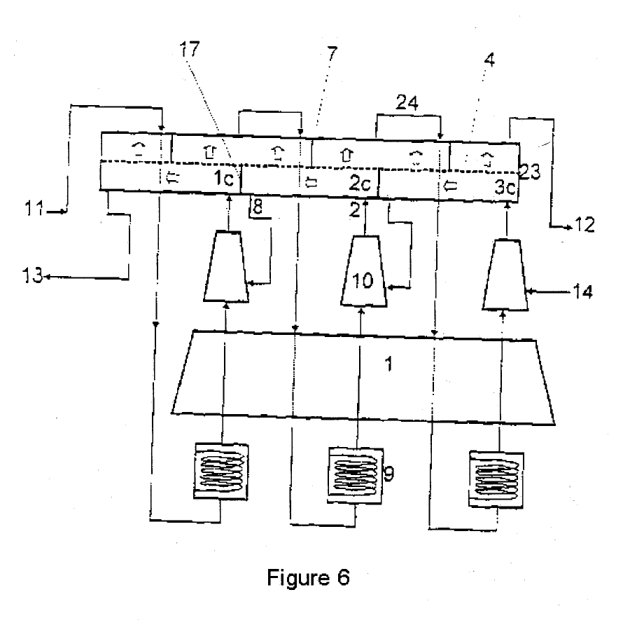

In FIG. 6, a cascade schema is shown with physical integration of the phase diffusers 23, using the concept depicted in FIG. 5. The simplification is appreciated in relation to the FIG. 4, to achieve the internal recirculation of flow. The only outlet 24 of the diffused flows of the first segment of each phase with the second segment of the following phase is also shown in FIG. 6.

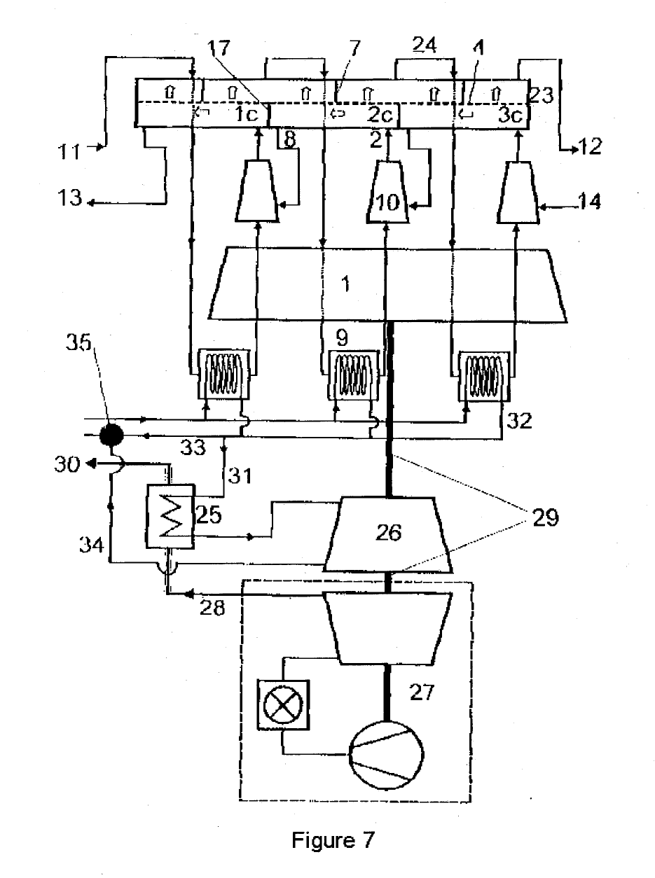

The highest thermal efficiency with the unit of the present invention is achieved by placing an evaporator 25 and a steam turbine 26 between the gas turbine 27 and the module, as shown in FIG. 7, so as to use the gases of the gas turbine outlet 28 to evaporate the water in the evaporator, which is expanded in the steam turbine producing mechanical work. This work is used to impel the compressor by means of a common axis 29, that connects it to the gas turbine. The steam turbine, as well as the same module, can be heated up outwardly, surrounding them with the exhaust gases in its discharge to the atmosphere 30. This possibility favors the demarcation of outdoor enrichment modular plants, allowing the reduction or even elimination of the external thermal isolation of the module. On the other hand, the energy efficiency of the modular unit can be increased by putting a small part 31 of cooling water 32 from the module heat exchangers 9 into the evaporator, and in its part 33, to condense the steam, just after it is expanded in the turbine 34, in the condenser of mixture 35.

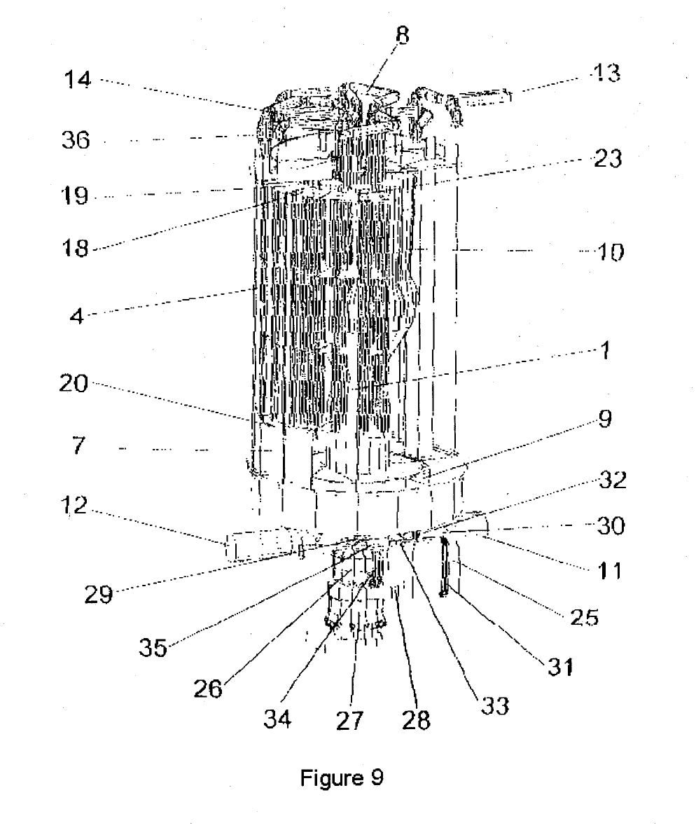

In FIG. 8 another embodiment of the invention can be observed, through the vertical longitudinal axis section of the enrichment unit shown in FIG. 9, according to the schema in FIG. 7. The component parts are shown to accomplish the described process, while the circulation of the gas to be enriched is indicated with arrows. In FIG. 8, the multiflow axial compressor 1, driven by the engine or the gas turbine 26, compresses the fluid that previously went through the heat exchanger 9, passing on the compressed fluid to the injector 10 and soon to the diffuser 23 that contains the membranes 4 and their support. The diffused fluid (enriched) passes on to the compressor in another section to accomplish the following enrichment phase. The non-diffused fluid returns to the injector 10 through the pipelines 8 and valves 36, where it is mixed with the fluid in circulation, leveling the pressures. In the center of the unit the non-destructive analyses probe 22 can be observed.

The use of a magnetic coupling among the compressor axis and the engine allows the mechanical disconnection of both axis and the elimination of insulation sealings in the module rotating axis. It can be located in the bottom end of the ring-shaped container in FIG. 8, where the set of steam and gas turbines is located underneath the compressor axis.

The enrichment modular unit of the present invention allows variance in the number of enrichment phases composing each module (or, what is the same, to vary the size of each enrichment phase) without varying the same module. By reducing or eliminating the need for a large diversity of components, it is possible to accomplish more efficient cascade schemas that can approximate, through a larger number of different flows, the ideal cascade of maximum efficiency. The use of size modules of the same dimensions (total flow) would simplify the production of the main components (containers, compressors and engines), thus achieving a higher degree of standardization. In general, this unit can be directed vertically as in FIG. 8, as well as horizontally.

Although particular articles embodying the present invention are expressly illustrated and described herein, it will be appreciated that system and method embodiments may be formed according to the description of the present invention. Unless otherwise expressly indicated, the description herein of articles of the present invention therefore extends to corresponding system and methods, and the description of system and articles of the present invention extends likewise to corresponding methods.

The invention may be embodied in other specific forms without departing from its essential characteristics. Steps may be reordered, performed concurrently, or omitted unless indicated otherwise. The described embodiments are to be considered in all respects only as illustrative and not restrictive. Any explanations provided herein of the scientific principles employed in the present invention are illustrative only. The scope of the invention is indicated by the appended claims rather than the description above. All changes that come within the meaning and range of equivalency of the claims are to be embraced within their scope.

I claim:

1. A gaseous diffusion enrichment modular unit comprising:
an integrated module having several separation and enrichment phases being connected in enrichment cascade;
each separation and enrichment phase taking place in an enrichment cell having separation means;
said module containing several flows of circulation, each said flow having a different degree of enrichment;
an injector operably connected to the inlet of each said cell;
an axial compressor for simultaneous compression of said flows, said compressor having flow separating means in the inlet and the outlet of said compressor;
diffusion means proximate to the outlet of each flow of said compressor, said diffusion means having at least a diffused flow outlet and a non-diffused flow outlet;
a flow recirculator connected to said non-diffused flow outlet in said diffusion means;
a thermal exchanger previous the following enrichment phase connected to said diffused flow outlet.

2. The gaseous diffusion enrichment modular unit according to claim 1, further comprising dividing means for dividing incoming flows into two or more sections to entry into said axial compressor, each section containing different enrichment flows.

3. The gaseous diffusion enrichment modular unit according to claim 2, is characterized because one or more enrichment cells mentioned, where each separation and enrichment phase is accomplished, have means of internal recirculation of fluids within the cell, with internal means to divide the diffused fluid area in one or more fractions of the total flow diffused in it, dividing the cell in two or more sections, that complete an enrichment phase with a depleted outlet in the first section that is connected to the following inlet, and so forth, and with an enriched outlet in the last section that is connected to the supply of the previous one, and so forth, while the diffused (enriched) flow outlet in the first section is connected to the thermal exchanger previously the following enrichment phase.

4. The gaseous diffusion enrichment modular unit, according to claim 3, is characterized because the means mentioned to divide the area of diffused fluid divide it, in a fraction of total flow diffused in the cell, dividing the cell in two sections, with a depleted outlet in the first section that is connected to the inlet of the second one and with an enriched outlet in the second section that is connected to the supply of the first one while the diffused (enriched) flow outlet in the first section is connected to the thermal exchanger previously the following enrichment phase.

5. The gaseous diffusion enrichment modular unit, according to claim 4, is characterized because all enrichment cells have said means of internal recirculation.

6. The gaseous diffusion enrichment modular unit, according to claims 4 or 5, is characterized because said internal means to divide the area of the diffused fluid are an internal dividing partition that determines the recirculation fraction.

7. The gaseous diffusion enrichment modular unit, according to claims 1 or 2, or 3, or 4, or 5, or 6, is characterized because the flow of each separation and enrichment phase, before going into said enrichment cell, passes on an injector.

8. The gaseous diffusion enrichment modular unit, according to claim 7, is characterized because said injector is of venturi type

9. The gaseous diffusion enrichment modular unit, according to claims 1 or 2, or 3, or 4, or 5, or 6, or 7, or 8, is characterized because said separation mean contains porous membrane.

10. The gaseous diffusion enrichment modular unit, according to claim 9, is characterized because said porous membranes are accomplished with multiple layers.

11. The gaseous diffusion enrichment modular unit, according claim 10, is characterized by said axial compressor be driven by a gas turbine.

12. The gaseous diffusion enrichment modular unit, according to claim 11, is characterized because the compressor axis and the gas turbine are magnetically coupled.

13. The gaseous diffusion enrichment modular unit, according to claims 11 or 12, is characterized by having an evaporator connected to the outlet gases of said gas turbine, and the outlet of said evaporator supplies a steam turbine mechanically connected to said gas turbine.

14. The gaseous diffusion enrichment modular unit, according to claim 13, is characterized by the outlet gases of said gas turbine, after passing through said evaporator, be introduced in heating means of the modular unit.

15. The gaseous diffusion enrichment modular unit, according to claim 14, is characterized by the cooling water from said thermal exchanger, previously each phase, enters the evaporator.

16. The gaseous diffusion enrichment modular unit, according to claims 1 or 2, or 3, or 4, or 5, or 6, or 7, or 8, or 9, or 10, or 11, or 12, or 13, or 14, or 15, is characterized by said enrichment cells having a flow separating cut-off rate from 0.4 to 0.6.

17. The gaseous diffusion enrichment modular unit, according to claim 16, is characterized because the value of said flow separating cut-off rate is 0.5.

18. The gaseous diffusion enrichment modular unit, according to claims 1 or 2, or 3, or 4, or 5, or 6, or 7, or 8, or 9, or 10, or 11, or 12, or 13, or 14, or 15, or 16, or 17, is characterized because the value of the work pressure ranges from 0.1 and 2 atmospheres.

19. The gaseous diffusion enrichment modular unit, according to claims 1 or 2, or 3, or 4, or 5, or 6, or 7, or 8, or 9, or 10, or 11, or 12, or 13, or 14, or 15, or 16, or 17, or 18, is characterized because said integrated module has a ring-shaped container form that contains the phases and its wide central part, and contains detection probes for non-destructive analysis.

20. The gaseous diffusion enrichment modular unit, according to claim 19, is characterized by said detection probes for non-destructive analysis be designed for _, _, total and neutronic techniques and active measurements.

21. The gaseous diffusion enrichment modular unit, according to claims 1 or 2, or 3, or 4, or 5, or 6, or 7, or 8, or 9, or 10, or 11, or 12, or 13, or 14, or 15, or 16, or 17, or 18, or 19, or 20, is characterized because the fluid to be enriched is uranium hexafluoride, to achieve hexafluoride from enriched uranium.

22. The gaseous diffusion enrichment modular unit, according to claims 1 or 2, or 3, or 4, or 5, or 6, or 7, or 8, or 9, or 10, or 11, or 12, or 13, or 14, or 15, or 16, or 17, or 18, or 19, or 20, is characterized because the fluid to be enriched is a hydrocarbon from natural gas.

23. A gaseous diffusion enrichment plant, which comprehends the enrichment modular units of any of the previous claims, is characterized because said modular units are connected in series.

24. A gaseous diffusion enrichment plant according to claim 23, is characterized because the numbers of phases of 1 or more said modular units are different, that is to say, the size of 1 or more enrichment phases varies.
